(19) United States
(12) Patent Application Publication
(10) Pub. No.: US 2018/0246659 A1
(43) Pub. Date: Aug. 30, 2018

(54) DATA BLOCKS MIGRATION

(71) Applicant: HEWLETT PACKARD ENTERPRISE DEVELOPMENT LP, Houston, TX (US)

(72) Inventors: Vivek Agarwal, Littleton, MA (US); Komateswar Dhanadevan, Bangalore (IN); Rupin T. Mohan, Littleton, MA (US); Douglas L. Voigt, Boise, ID (US)

(21) Appl. No.: 15/445,496

(22) Filed: Feb. 28, 2017

(51) Int. Cl. G06F 3/06; G06F 17/30; G06N 3/04

(52) U.S. Cl. CPC G06F 3/0619; G06F 17/303; G06F 3/0647; G06F 3/065; G06F 3/067; G06N 3/04

(57) ABSTRACT

Examples disclosed herein relate to migration of data blocks. In an example, data blocks for migration from a source data storage device to a destination data storage device may be identified. A migration priority for each of the data blocks may be determined. The determination may comprise determining a plurality of parameters for each of the data blocks based on an analysis of respective input/output (I/O) operations of the data blocks in relation to a host system. The plurality of parameters may be provided as an input to an input layer of an artificial neural network engine. The input may be processed by a hidden layer of the artificial neural network engine. An output may be provided by an output layer of the artificial neural network engine. In an example, the output may include a migration priority for each of the data blocks.

### BACKGROUND

Organizations may need to deal with a vast amount of business data these days, which could range from a few terabytes to multiple petabytes of data. Loss of data or inability to access data may impact an enterprise in various ways such us loss of potential business and lower customer satisfaction.

### BRIEF DESCRIPTION OF THE DRAWINGS

For a better understanding of the solution, examples will now be described, purely by way of example, with reference to the accompanying drawings, in which:

FIG. 1 is a diagram of an example computing environment for migrating data blocks;

FIG. 2 is a block diagram of an example data storage system for migrating data blocks;

FIG. 3 is a block diagram of an example data storage system for migrating data blocks;

FIG. 4 is a block diagram of an example method for migrating data blocks; and

FIG. 5 is a block diagram of an example system including instructions in a machine-readable storage medium for migrating data blocks.

### DETAILED DESCRIPTION

Enterprises may need to manage a considerable amount of data these days. Ensuring that mission-critical data is continuously available may be a desirable aspect of a data management process. Organizations planning to upgrade their information technology (IT) infrastructure, especially storage systems, may expect zero downtime for their data during a data migration process for various reasons such as, for example, meeting a Service Level Agreement (SLA). Thus, ensuring that there's no interruption in data availability while the data is being migrated from a source data storage device to a destination data storage device may be a desirable aspect of a data management system. The task may pose further challenges in a federated environment where bandwidth may be shared between a host application and a migration application.

To address this issue, the present disclosure describes various examples for migrating data blocks. As used herein, a “data block” may correspond to a specific number of bytes of physical disk space. In an example, data blocks for migration from a source data storage device to a destination data storage device may be identified. A migration priority for each of the data blocks may be determined. In an example, the determination may include determining a plurality of parameters for each of the data blocks based on an analysis of respective input/output (I/O) operations of the data blocks in relation to a host system. The parameters may be provided as an input to an input layer of an artificial neural network engine. The input may be processed by a hidden layer of the artificial neural network engine. An output layer of the artificial neural network engine may provide an output, which may include, for example, a migration priority for each of the data blocks.

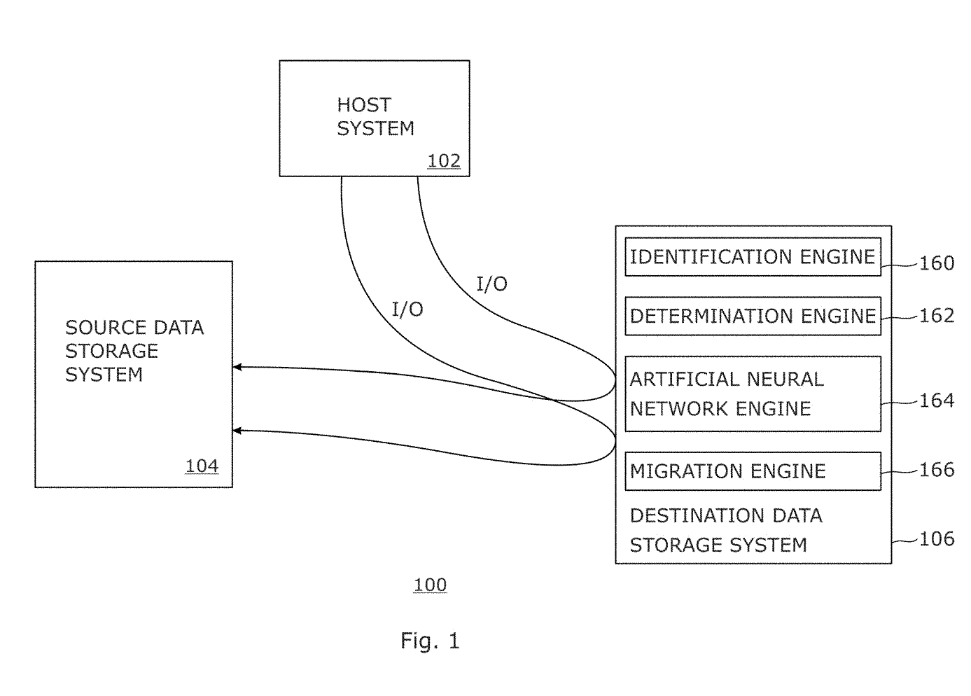

FIG. 1 is a block diagram of an example computing environment 100 for migrating data blocks. Computing environment 100 may include a host system 102, a source data storage device 104, and a destination data storage device 106. Although one host system, one source data storage device, and one destination data storage device is shown in FIG. 1, other examples of this disclosure may include more than one host system, more than one source data storage device, and/or more than one destination data storage device.

Host system 102 may be any type of computing device capable of executing machine-readable instructions. Examples of host system 102 may include, without limitation, a server, a desktop computer, a notebook computer, a tablet computer, a thin client, a mobile device, a personal digital assistant (PDA), a phablet, and the like. In an example, host system 102 may include one or more applications, for example, an email application and a database.

In an example, source data storage device 104 and destination data storage device 106 may each be an internal storage device, an external storage device, or a network attached storage device. Some non-limiting examples of source data storage device 104 and destination data storage device 106 may each include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, source data storage device 104 and destination data storage device 106 may each be a Direct Attached Storage (DAS) device, a Network Attached Storage (NAS) device, a Redundant Array of Inexpensive Disks (RAID), a data archival storage system, or a block-based device over a storage area network (SAN). In another example, source data storage device 104 and destination data storage device 106 may each be a storage array, which may include one or more storage drives (for example, hard disk drives, solid state drives, etc.). In another example, source data storage device 104 (for example, a disk drive) and destination data storage device 106 (for example, a disk drive) may be part of the same data storage system (for example, a storage array).

In an example, the physical storage space provided by source data storage device 104 and destination data storage device 106 may each be presented as a logical storage space. Such logical storage space (also referred as “logical volume”, “virtual disk”, or “storage volume”) may be identified using a “Logical Unit”. In another example, physical storage space provided by source data storage device 104 and destination data storage device 106 may each be presented as multiple logical volumes. If source data storage device 104 (or destination data storage device 106) is a physical disk, a logical unit may refer to the entire physical disk, or a subset of the physical disk. In another example, if source data storage device 104 (or destination data storage device 106) is a storage array comprising multiple storage disk drives, physical storage space provided by the disk drives may be aggregated as a single logical storage space or multiple logical storage spaces.

Host system 102 may be in communication with source data storage device 104 and destination data storage device 106, for example, via a network (not illustrated). The computer network may be a wireless or wired network. The computer network may include, for example, a Local Area Network (LAN), a Wireless Local Area Network (WAN), a Metropolitan Area Network (MAN), a Storage Area Network (SAN), a Campus Area Network (CAN), or the like. Further, the computer network may be a public network (for example, the Internet) or a private network (for example, an intranet).

Source data storage device 104 may be in communication with destination data storage device 106, for example, via a network (not illustrated). Such a network may be similar to the network described above. Source data storage device 104 may communicate with destination data storage device 106 via a suitable interface or protocol such as, but not limited to, Internet Small Computer System Interface (iSCSI), Fibre Channel, Fibre Connection (FICON), HyperSCSI, and ATA over Ethernet. In an example, source data storage device 104 and destination data storage device 106 may be included in a federated storage environment. As used here, “federated storage” may refer to peer-to-peer storage devices that operate as one logical resource managed via a common management platform. Federated storage may represent a logical construct that groups multiple storage devices for concurrent, non-disruptive, and/or bidirectional data mobility. Federated storage may support non-disruptive data movement between storage devices for load balancing, scalability and/or storage tiering.

In an example, destination data storage device 106 may include an identification engine 160, a determination engine 162, an artificial neural network engine 164, and a migration engine 166. In another example, engines 160, 162, 164, and 166 may be present on source data storage device 104. In a further example, engines 160, 162, 164, and 166 may be present on a separate computing system (not illustrated) in computing environment 100. In a further example, if source data storage device 104 and destination data storage device 106 are members of the same data storage system (for example, a storage array), engines 160, 162, 164, and 166 may be present, for example, as a part of a management platform on the data storage system.

Engines 160, 162, 164, and 166 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of destination data storage device 106. In some examples, the at least one machine-readable storage medium may store instructions that, when executed by the at least one processing resource, at least partially implement some or all engines of destination data storage device 106. In such examples, destination data storage device 106 may include the at least one machine-readable storage medium storing the instructions and the at least one processing resource to execute the instructions.

Identification engine 160 on destination data storage device 106 may be used to identify data blocks for migration from source data storage device 104 to destination data storage device 106. In an example, identification engine 160 may be used by a user to select data blocks for migration from source data storage device 104 to destination data storage device 106. In this regard, identification engine 160 may provide a user interface for a user to select the data blocks for migration. In another example, identification engine 160 may automatically select data blocks for migration from source data storage device 104 to destination data storage device 106 based on a pre-defined parameter (for example, amount of data in a data block).

Determination engine 162 on destination data storage device 106 may determine a migration priority for each of the data blocks identified by identification engine 160. In an example, the determination may include determining a plurality of parameters for each of the identified data blocks based on an analysis of respective input/output (I/O) operations of the identified data blocks in relation to host system 102. In an example, determination engine 162 may place destination data storage device 106 in a pass-through mode. In the pass-through mode, the input/output (I/O) operations of the identified data blocks in relation to host system may be routed to source data storage device 104 via destination data storage device 106. The routing may allow determination engine 162 to determine host I/O traffic patterns (at destination data storage device 106) in relation to various parameters for each of the identified data blocks.

Examples of the parameters determined by determination engine 162 for each of the identified data blocks may include an amount of write I/O operations to a data block in relation to host 102; an amount of read I/O operations to a data block in relation to host 102; input/output operations per second (IOPs) of a data block; a range of logical block addresses (LBAs) impacted by read/write I/O operations of a data block; an I/O block size requested by an application on host 102 from a data block; and a data block priority assigned to a data block by a user. The data block priority assigned to a data block by a user may be a numerical value (for example, 1, 2, 3, 4, 5, etc.) or a non-numerical value (for example, high, medium, or low).

In an example, the amount of write I/O operations to a data block may be considered as a parameter since if number of write I/O operations increase for a data block, logical blocks may be frequently modified, which may impact the duration of migration for the data block. Likewise, the amount of read I/O operations to a data block may be considered since they may impact network bandwidth during migration of the data block. The input/output operations per second (IOPs) of a data block may be considered since a data block with high activity may consume more network bandwidth. The range of logical block addresses (LBAs) impacted by read/write I/O operations of a data block may be considered as a parameter since if the blocks at source data storage device are changed to a larger LBA range, it may affect the duration of migration of the data block, and consume more network bandwidth. The I/O block size requested by an application on host (for example, 102) from a data block may be taken into consideration since in conjunction with a write I/O operation it may impact the amount of logical blocks that are changed at any given time. For example, in case of an unstructured application, the logical block size may be large which, in conjunction with a write I/O operation, may impact the duration of migration of a data block since the migration process may involve multiple phases of regions of sequential blocks.

In an example, once the parameters for each of the identified data blocks are determined, determination engine 162 may provide the parameters as an input to an input layer of an artificial neural network (ANN) engine 164 on destination data storage device 106. As used herein, an artificial neural network engine 164 may refer to an information processing system comprising interconnected processing elements that are modeled on the structure of a biological neural network. The interconnected processing elements may be referred to as “artificial neurons” or “nodes”.

In an example, artificial neural network engine 164 may comprise a plurality of artificial neurons, which may be organized into a plurality of layers. In an example, artificial neural network engine 164 may comprise three layers: an input layer, a hidden layer, and an output layer. In an example, artificial neural network engine 164 may be a feedforward neural network wherein connections between the units may not form a cycle. In the feedforward neural network, the information may move in one direction, from the input layer, through the hidden layer, and to the output layer. There may be no cycles or loops in the network.

In an example, artificial neural network engine 164 may be based on a backpropagation architecture. The backpropagation may be used to train artificial neural network engine 164. When an input vector is presented to the artificial neural network engine 164, it may be propagated forward through artificial neural network engine 164, layer by layer, until it reaches the output layer. The output of the network may be compared to the desired output, using a loss function, and an error value may be calculated for each of the artificial neurons in the output layer. The error values may be propagated backwards, starting from the output, until each artificial neuron has an associated error value which roughly represents its contribution to the original output. Backpropagation may use these error values to calculate the gradient of the loss function with respect to the weights in the network. This gradient may be provided to an optimization method, which in turn may use it to update the weights, in an attempt to minimize the loss function. As artificial neural network engine is trained, the neurons in the intermediate layers may organize themselves in such a way that the different neurons may learn to recognize different characteristics of the total input. After training if an arbitrary input pattern is presented to artificial neural network engine, neurons in the hidden layer of the network may respond with an output if the new input contains a pattern that resembles a feature that the individual neurons have learned to recognize during their training.

In an example, the input layer of artificial neural network engine 164 may include six artificial neurons, the hidden layer may include three artificial neurons, and the output layer may include one artificial neuron. In some other examples, the input layer may include more or less than six artificial neurons in the input layer, the hidden layer may include more or less than three artificial neurons, and the output layer may include more than one artificial neuron.

In an example, determination engine 162 may provide one separate parameter as an input to each of the six artificial neurons of the input layer of artificial neural network (ANN) engine 164 on destination data storage device 106. In an example, the six parameters may include an amount of write I/O operations to a data block in relation to host 102; an amount of read I/O operations to a data block in relation to host 102; input/output operations per second (IOPs) of a data block; a range of logical block addresses (LBAs) impacted by read/write I/O operations of a data block; an I/O block size requested by an application on host 102 from a data block; and a data block priority assigned to a data block by a user. In some examples, a relative weight or importance may be assigned to each parameter as part of the input to the input layer of artificial neural network engine 104. Table 1 below illustrates an example of relative weights (1, 2, 3, 4, 5, and 6) assigned to input parameters.

TABLE 1

| Parameter | Relative weights (descending order) |
|---|---|
| IOPS | 6 |
| Write I/O % | 5 |
| LBA Range | 4 |
| Block Size | 3 |
| Data block | 2 |
| Priority | |
| Read I/O % | 1 |

In response to receipt of input parameters (and associated weights, if assigned) by the input layer, artificial neurons in the hidden layer, which may be coupled to the input layer, may process the input parameters, for example, by using an activation function. The activation function of a node may define the output of that node given an input or set of inputs. An activation function may be considered as a decision making function that determines presence of a particular feature. For example, the activation function may be used by an artificial neuron in the hidden layer to decide what the activation value of the unit may be based on a given set of input values received from the input layer. The activation value of many such units may then be used to make a decision based on the input.

Once the input parameters (and associated weights, if any) are processed by the hidden layer, the artificial neuron in the output layer, which may be coupled to the hidden layer of the artificial neural network engine 164 may provide an output. In an example, the output may include a migration priority for each of the identified data blocks. Thus, each data block that is identified for migration may be assigned a migration priority by determination engine 162. The migration priority may be assigned using a numeral (for example, 1, 2, 3, 4, and 5) or a non-numeral value (for example, High, Medium, and Low, which may represent relative values). In an example, determination engine 162 may identify an appropriate storage tier for each of the data blocks based on their respective migration priorities. In an example, storage media available in computing environment 100 may be classified into different tiers based on, for example, performance, availability, cost, and recovery requirements. In an example, determination engine 162 may identify a relatively higher storage tier for a data block with a relatively higher migration priority.

In an example, before determination engine 162 may be used to determine a migration priority for each of the identified data blocks, determination engine 162 may calibrate artificial neural network engine 164 by placing artificial neural network engine 164 in a learning phase. In the learning phase, host system I/O operations with respect to source data storage device 104 may be routed via destination data storage device 106 for a pre-defined time interval, which may range from a few minutes to hours. In another example, the calibration may occur outside of destination data storage device 106, for example, via a background process fed by I/O operations captured in real time at source data storage device 104. The pre-defined period may be user-defined or system-defined. During the time interval, determination engine 162 may determine host I/O traffic patterns (at destination data storage device 106) in relation to various parameters for each identified data block. These parameters may be similar to those mentioned earlier. The data collected during the time period may be provided as input data to the input layer of the artificial neuron network engine 164 by determination engine 162. Table 2 illustrates 26 samples of I/O data in relation to six input parameters for a set of data blocks.

TABLE 2

| | Write | Read | | | | Data | |
|---|---|---|---|---|---|---|---|
| Sample | I/O | I/O | | LBA | Block | block | Migration |
| I/O | (%) | (%) | IOPS | Range | Size | priority | priority |
| I:O | 100 | 0 | 100000 | 50 | 64000 | 4 | 0.9000 |
| I:1 | 100 | 0 | 100000 | 50 | 64000 | 5 | 0.9100 |
| I:2 | 100 | 0 | 100000 | 50 | 64000 | 1 | 0.8500 |
| I:3 | 90 | 10 | 100000 | 50 | 64000 | 3 | 0.8500 |
| I:4 | 80 | 20 | 120000 | 50 | 64000 | 3 | 0.8500 |
| I:5 | 80 | 20 | 120000 | 60 | 64000 | 3 | 0.8700 |
| I:6 | 80 | 20 | 120000 | 60 | 12800 | 3 | 0.8800 |
| I:7 | 70 | 30 | 120000 | 60 | 12800 | 3 | 0.8000 |
| T:8 | 70 | 30 | 140000 | 60 | 12800 | 3 | 0.8100 |
| I:9 | 30 | 70 | 140000 | 60 | 12800 | 3 | 0.4000 |
| I:10 | 30 | 70 | 140000 | 50 | 12800 | 3 | 0.3900 |
| I:11 | 30 | 70 | 120000 | 60 | 12800 | 3 | 0.3700 |
| I:12 | 50 | 50 | 120000 | 50 | 12800 | 3 | 0.5000 |
| I:13 | 50 | 50 | 120000 | 50 | 64000 | 3 | 0.4500 |
| I:14 | 50 | 50 | 120000 | 50 | 512 | 3 | 0.4000 |
| I:15 | 60 | 40 | 120000 | 50 | 512 | 3 | 0.4100 |
| I:16 | 0 | 0 | 0 | 0 | 0 | 5 | 0.1000 |
| I:17 | 0 | 0 | 0 | 0 | 0 | 3 | 0.0500 |
| T:18 | 0 | 0 | 0 | 0 | 0 | 1 | 0.0100 |
| I:19 | 50 | 50 | 120000 | 50 | 2000 | 3 | 0.4200 |
| I:20 | 50 | 50 | 120000 | 50 | 1000 | 3 | 0.4100 |
| I:21 | 50 | 50 | 140000 | 50 | 2000 | 3 | 0.4500 |
| I:22 | 60 | 40 | 160000 | 50 | 64000 | 5 | 0.6000 |
| I:23 | 60 | 40 | 160000 | 70 | 64000 | 3 | 0.7000 |
| I:24 | 100 | 0 | 100000 | 50 | 64000 | 3 | 0.8600 |
| I:25 | 100 | 0 | 100000 | 60 | 64000 | 3 | 0.8600 |

In response to receipt of the input parameters (and associated weights, if assigned) by the input layer, the hidden layer may process the input parameters, for example, by using an activation function. Once the input parameters (and associated weights, if any) are processed by the hidden layer, the output layer may identify a set of high LBA impact data blocks. The output layer may also determine an order of migration priority for the data blocks. The output layer may also determine a storage tier for each of the data blocks based on their respective migration priorities.

The learning (or training) phase of artificial neural network engine 164 may be an iterative process in which I/O traffic samples of data blocks may be presented one at a time to artificial neural network engine, and any weights associated with the input values may be adjusted each time. After all samples are presented, the process may be repeated again until it reaches the desired error level. The initial weights may be set to any values, for example the initial weights may be chosen randomly. Artificial neural network engine 164 may process training samples one at a time using weights and functions in the hidden layer, and then compare the resulting output against a desired output. Artificial neural network engine 164 may use back propagation to measure the margin of error and adjust weights, before the next sample is processed. Once artificial neural network engine is trained or calibrated using the samples with acceptable margin of error, artificial neural network engine may be used by determination engine to determine a migration priority for a given set of data blocks, as explained earlier.

Once a migration priority is determined for each of the identified data blocks by determination engine 162, migration engine 166 may migrate the data blocks from source data storage device 104 to destination data storage device 106 based on their migration priority. In an example, in the event determination engine 162 identifies a storage tier for a data block based on its migration priority, migration engine 166 may migrate the data block to the identified storage tier.

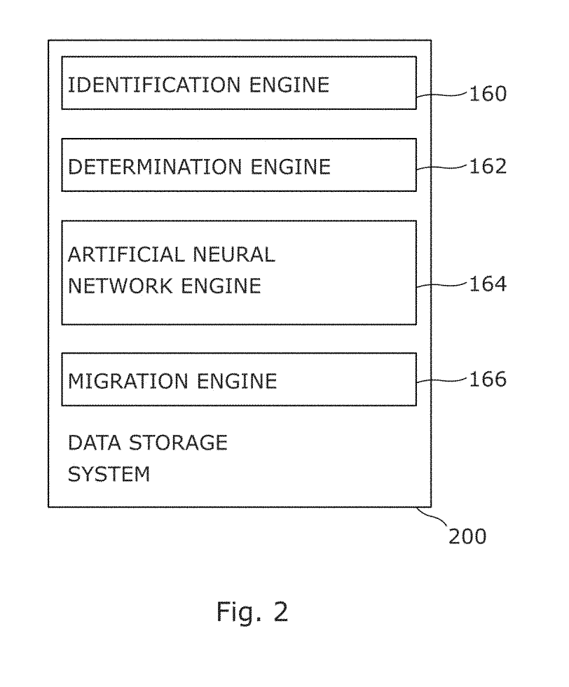

FIG. 2 is a block diagram of an example data storage system 200 for migrating data blocks. In an example, system 200 may be implemented by any suitable device, as described herein in relation to source data storage device 104 or destination data storage device 106 of FIG. 1, for example.

Data storage system 200 may be an internal storage device, an external storage device, or a network attached storage device. Some non-limiting examples of storage system 200 may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In an example, data storage system 200 may be a Direct Attached Storage (DAS) device, a Network Attached Storage (NAS) device, a Redundant Array of Inexpensive Disks (RAID), a data archival storage system, or a block-based device over a storage area network (SAN). In another example, data storage system 200 may be a storage array, which may include one or more storage drives (for example, hard disk drives, solid state drives, etc.).

In an example, data storage system 200 may include an identification engine 160, a determination engine 162, an artificial neural network engine 164, and a migration engine 166. In an example, identification engine 160 may identify data blocks for migration from a source data storage device (for example, 104) to data storage system 200. Determination engine 162 may determine a migration priority for each of the data blocks. In an example, the determination may include determining a plurality of parameters for each of the data blocks based on an analysis of respective input/output (I/O) operations of the data blocks in relation to a host system. Determination engine 162 may provide the plurality of parameters as an input to an input layer of artificial neural network engine 164. The input may be processed by a hidden layer of the artificial neural network engine 164, wherein the hidden layer may be coupled to the input layer. An output layer of the artificial neural network engine 164, which may be coupled to the hidden layer may provide an output. In an example, the output may include a migration priority for each of the data blocks. Migration engine 166 may migrate the data blocks based on the respective migration priorities of the data blocks.

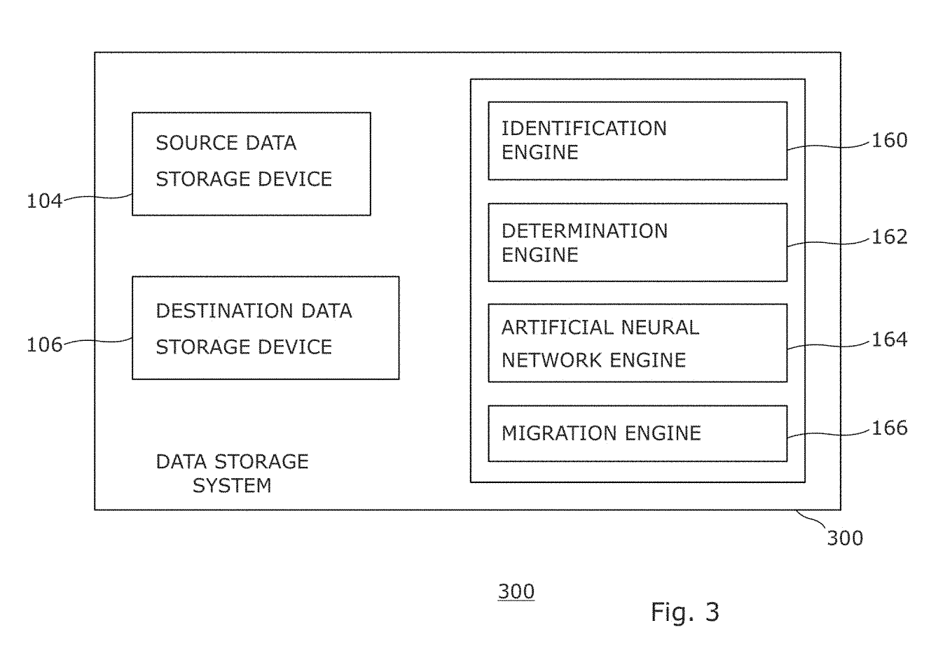

FIG. 3 is a block diagram of an example data storage system 300 for migrating data blocks. In an example, data storage system 300 may be a storage array, which may include one or multiple storage drives (for example, hard disk drives, solid state drives, etc.). In an example, data storage system 300 may include a source data storage device (for example, 104) and a destination data storage device (for example, 106).

In an example, data storage system 300 may include an identification engine 160, a determination engine 162, an artificial neural network engine 164, and a migration engine 166. In an example, identification engine 160 may identify data blocks for migration from source data storage device 104 to destination data storage device 106. Determination engine 162 may determine a migration priority for each of the data blocks. In an example, the determination may include determining a plurality of parameters for each of the data blocks based on an analysis of respective input/output (I/O) operations of the data blocks in relation to a host system. Determination engine 162 may provide the plurality of parameters as an input to an input layer of artificial neural network engine 164. The input may be processed by a hidden layer of the artificial neural network engine 164, wherein the hidden layer may be coupled to the input layer. An output layer of the artificial neural network engine 164, which may be coupled to the hidden layer, may provide an output. In an example, the output may include a migration priority for each of the data blocks. Migration engine 166 may migrate the data blocks based on the respective migration priorities of the data blocks.

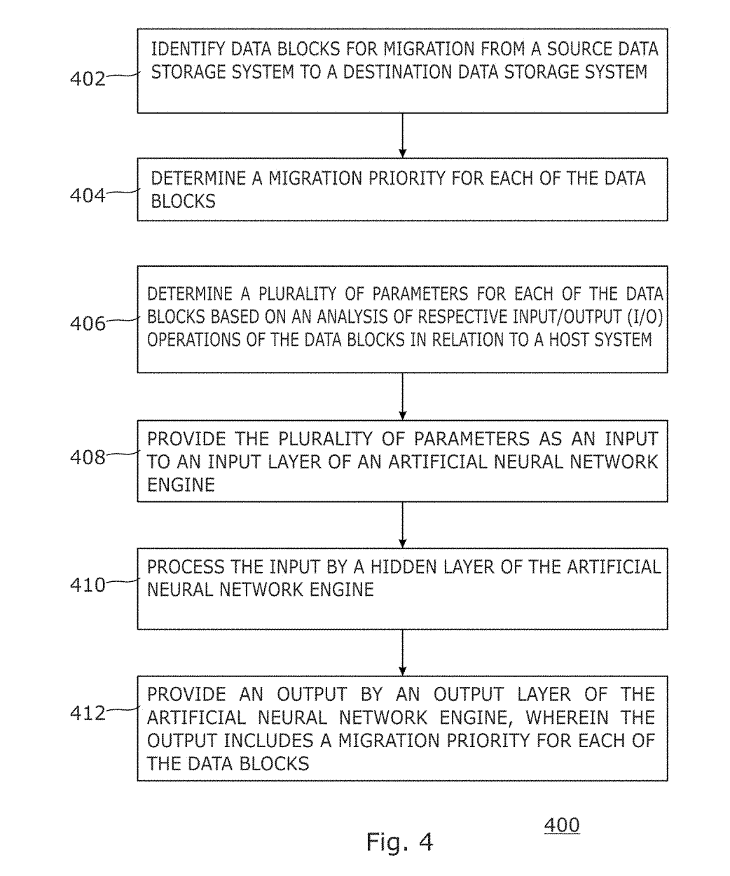

FIG. 4 is a block diagram of an example method 400 for migrating data blocks. The method 400, which is described below, may be partially or fully executed on a device such as source data storage device 104 and destination data storage device 106 of FIG. 1, data storage system 200 of FIG. 2, or data storage system 300 of FIG. 3. However, other suitable computing devices may execute method 400 as well. At block 402, data blocks for migration from a source data storage device to a destination data storage device may be identified. At block 404, a migration priority for each of the data blocks may be determined at the destination data storage device. In an example, the determination may comprise determining a plurality of parameters for each of the data blocks based on an analysis of respective input/output (I/O) operations of the data blocks in relation to a host system (block 406). At block 408, the plurality of parameters may be provided as an input to an input layer of an artificial neural network engine. At block 410, the input may be processed by a hidden layer of the artificial neural network engine, wherein the hidden layer may be coupled to the input layer. At block 412, an output may be provided by an output layer of the artificial neural network engine. In an example, the output may include a migration priority for each of the data blocks.

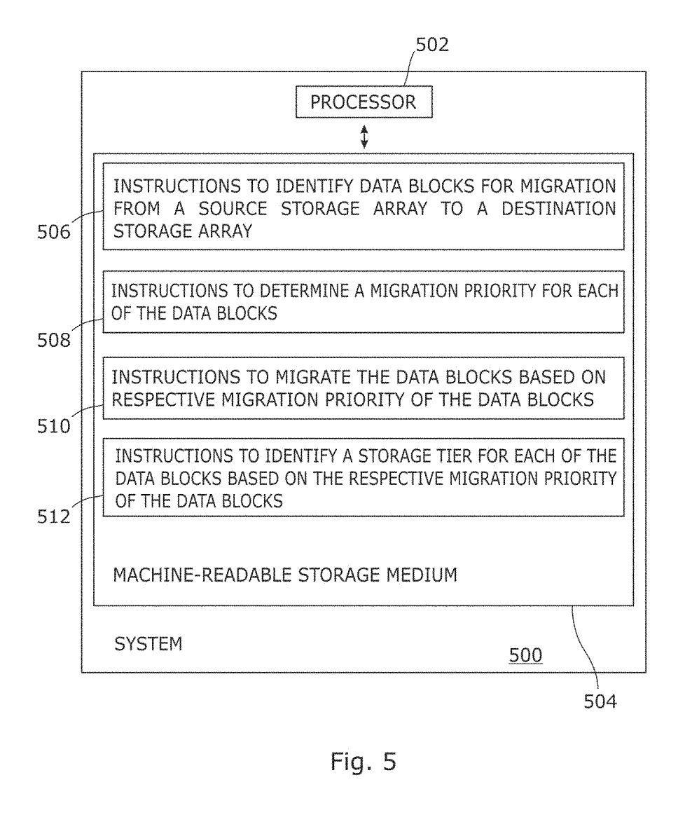

FIG. 5 is a block diagram of an example system 500 for migrating data blocks. System 500 includes a processor 502 and a machine-readable storage medium 504 communicatively coupled through a system bus. In an example, system 500 may be analogous to source data storage device 104 or destination data storage device 106 of FIG. 1, data storage system 200 of FIG. 2, or data storage system 300 of FIG. 3. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium.

Machine-readable storage medium 504 may store instructions 506, 508, 510, and 512. In an example, instructions 506 may be executed by processor 502 to identify data blocks for migration from a source storage array to a destination storage array. Instructions 508 may be executed by processor 502 to determine a migration priority for each of the data blocks. In an example, the instructions 508 may comprise instructions to determine, at the destination storage array, a plurality of parameters for each of the data blocks based on an analysis of respective input/output (I/O) operations of the data blocks in relation to a host system. The instructions 508 may further include instructions to provide the plurality of parameters as an input to an input layer of an artificial neural network engine. The instructions 508 may further include instructions to process the input by a hidden layer of the artificial neural network engine, wherein the hidden layer is coupled to the input layer. The instructions 508 may further include instructions to provide an output by an output layer of the artificial neural network engine, wherein the output layer may be coupled to the hidden layer. In an example, the output may include a migration priority for each of the data blocks. Instructions 510 may be executed by processor 502 to migrate the data blocks based on the respective migration priorities of the data blocks. Instructions 512 may be executed by processor 502 to identify a storage tier for each of the data blocks based on the respective migration priorities of the data blocks.

For the purpose of simplicity of explanation, the example method of FIG. 5 is shown as executing serially, however it is to be understood and appreciated that the present and other examples are not limited by the illustrated order. The example systems of FIGS. 1, 2, 3, and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings and benefits of the subject matter described herein. Other substitutions, modifications and changes may be made without departing from the spirit of the present solution. All of the features disclosed in this specification (including any accompanying claims, abstract and drawings), and/or all of the parts of any method or process so disclosed, may be combined in any combination, except combinations where at least some of such features and/or parts are mutually exclusive.

1. A method comprising:
identifying data blocks for migration from a source data storage device to a destination data storage device; and
determining a migration priority for each of the data blocks, wherein the determining comprises:
determining a plurality of parameters for each of the data blocks based on an analysis of respective input/output (I/O) operations of the data blocks in relation to a host system;
providing the plurality of parameters as an input to an input layer of an artificial neural network engine;
processing the input by a hidden layer of the artificial neural network engine, wherein the hidden layer is coupled to the input layer; and
providing an output by an output layer of the artificial neural network engine, wherein the output layer is coupled to the hidden layer, and wherein the output includes a migration priority for each of the data blocks.

2. The method of claim 1, further comprising:
migrating the data blocks from the source data storage device to the destination data storage device based on respective migration priorities of the data blocks.

3. The method of claim 1, wherein determining the migration priority for each of the data blocks comprises:
placing the destination data storage device in a pass-through mode, wherein in the pass-through mode, the input/output (I/O) operations of the data blocks in relation to the host system are routed to the source data storage device via the destination data storage device.

4. The method of claim 1, further comprising:
identifying a storage tier for each of the data blocks based on the respective migration priorities of the data blocks.

5. The method of claim 4, further comprising migrating each of the data blocks to respective storage tiers.

6. A data storage system comprising:
an identification engine to identify data blocks for migration from a source data storage device to the data storage system;
a determination engine to determine a migration priority for each of the data blocks, wherein the determination comprises to:
determine a plurality of parameters for each of the data blocks based on an analysis of respective input/output (I/O) operations of the data blocks in relation to a host system;
provide the plurality of parameters as an input to an input layer of an artificial neural network engine;
process the input by a hidden layer of the artificial neural network engine, wherein the hidden layer is coupled to the input layer; and
provide an output by an output layer of the artificial neural network engine, wherein the output layer is coupled to the hidden layer, and wherein the output includes a migration priority for each of the data blocks; and
a migration engine to migrate the data blocks based on respective migration priorities of the data blocks.

7. The data storage system of claim 6, wherein the parameters include at least one of an amount of write I/O operations to a data block in relation to the host, an amount of read I/O operations to a data block in relation to the host, input/output operations per second (IOPs) of a data block, a range of logical block addresses (LBAs) impacted by read/write I/O operations of a data block, an I/O block size requested by an application on the host from a data block, and a data block priority assigned to a data block by a user.

8. The data storage system of claim 6, wherein the determination engine is to calibrate the artificial neural network engine with samples of I/O operations of the data blocks in relation to the host system.

9. The data storage system of claim 6, wherein the artificial neural network engine is included in the data storage system.

10. The data storage system of claim 6, wherein the input/output (I/O) operations of the data blocks in relation to the host system are routed to the source data storage device via the destination data storage system.

11. A non-transitory machine-readable storage medium comprising instructions, the instructions executable by a processor to:
identify data blocks for migration from a source storage array to a destination storage array;
determine a migration priority for each of the data blocks, wherein the instructions to determine comprise instructions to:
determine a plurality of parameters for each of the data blocks based on an analysis of respective input/output (I/O) operations of the data blocks in relation to a host system;
provide the plurality of parameters as an input to an input layer of an artificial neural network engine;
process the input by a hidden layer of the artificial neural network engine, wherein the hidden layer is coupled to the input layer; and
provide an output by an output layer of the artificial neural network engine, wherein the output layer is coupled to the hidden layer, and wherein the output includes a migration priority for each of the data blocks;
migrate the data blocks based on respective migration priorities of the data blocks; and
identify a storage tier for each of the data blocks based on the respective migration priorities of the data blocks.

12. The storage medium of claim 11, wherein the source storage array and the destination storage array are included in a federated storage system environment.

13. The storage medium of claim 11, wherein the instructions to provide the plurality of parameters include instructions to:
assign a relative weight to each parameter in the plurality of parameters; and
provide the relative weight assigned to each parameter as the input to the input layer of the artificial neural network engine.

14. The storage medium of claim 11, wherein:
the input layer of the artificial neural network engine includes six artificial neurons;
the hidden layer of the artificial neural network engine includes three artificial neurons; and
the output layer of the artificial neural network engine includes one artificial neuron.

15. The storage medium of claim 14, wherein the instructions to provide the plurality of parameters include instructions to provide a separate parameter as input to each of the six artificial neurons in the artificial neural network engine.
